(19) United States
(12) Patent Application Publication
(10) Pub. No.: US 2026/0135178 A1
(43) Pub. Date: May 14, 2026

(54) BATTERY RECYCLING PLANT AND PROCESS

(71) Applicant: BASF SE, Ludwigshafen am Rhein (DE)

(72) Inventors: Marc DUCHARDT, Ludwigshafen (DE); Fabian SEELER, Ludwigshafen (DE); Wolfram WILK, Ludwigshafen (DE); Tobias ELWERT, Schwarzheide (DE); Wolfgang ROHDE, Ludwigshafen (DE); Kerstin SCHIERLE-ARNDT, Ludwigshafen (DE); Maximilian RANG, Ludwigshafen (DE); Anne-Marie Caroline ZIESCHANG, Ludwigshafen (DE); Regina VOGELSANG, Ludwigshafen (DE)

(21) Appl. No.: 19/119,172

(22) PCT Filed: Oct. 31, 2023
(86) PCT No.: PCT/EP2023/080411

§ 371 Date: Apr. 8, 2025

(30) Foreign Application Priority Data
Nov. 3, 2022 (EP) 22205375.3

(51) Int. Cl. H01M 10/54; B09B 3/35; B09B 3/38; B09B 3/40; B09B 101/16; C22B 1/248

(52) U.S. Cl. CPC H01M 10/54; B09B 3/35; B09B 3/38; B09B 3/40; C22B 1/248; B09B 2101/16

(57) ABSTRACT

Disclosed herein are a plant for recycling lithium ion battery materials, in particular lithium ion batteries, and a process for recovering valuable materials from lithium ion battery material.

### FIELD OF THE INVENTION

The present disclosure relates to a plant for recycling lithium ion battery materials, in particular lithium ion batteries, and to a process for recovering valuable materials from lithium ion battery material.

### BACKGROUND

Lithium ion battery materials are complex mixtures of various elements and compounds. For example, many lithium ion battery materials contain valuable metals such as lithium, aluminum, copper, nickel, cobalt, and/or manganese. It may be desirable to recover various elements and compounds from lithium ion battery materials. For example, it may be advantageous to recover lithium, aluminum, copper, nickel, cobalt, and/or manganese. Accordingly, there is a need for devices and processes for recycling lithium ion battery material.

DE 10 2015 207 843 A1 discloses a recycling plant for used batteries. The batteries are pretreated in a complex manner, in particular discharged and dismantled, before they are comminuted and dried. This increases the operating costs of the device, in particular because of the labor required.

EP 3 641 036 A1 relates to a plant for recycling used batteries, comprising a comminuting device to comminute used batteries in a comminuting space. The plant includes a drying device, arranged downstream of the comminuting device, to dry the comminuted batteries. The plant includes an intermediate storage device arranged between the comminuting device and the drying device. The plant includes a stirring means to keep the comminuted batteries received in the intermediate storage space in motion. The plant includes a respective supply line for inert gas for each of the comminuting space of the comminuting device, the intermediate storage space of the intermediate storage device, and a drying space of the drying device.

CN 111 495 925 A discloses a waste lithium battery pyrolyzation, defluorination and dechlorination method. The method comprises the steps of discharging and dismantling waste lithium batteries; conducting primary crushing, drying a crushed product, conducting primary separation on the dried crushed product, conducting secondary crushing and secondary separation, conducting pyrolyzation, defluorination, dechlorination and in-situ fluorine and chlorine absorption on a separated material, scattering and screening a pyrolyzed product to obtain black powder, conducting washing and separation on copper and aluminum foil to obtain copper and aluminum products, pyrolyzing and drying flue gas, conducting condensing, dust removal, spraying, adsorption and ignition on the flue gas, and then discharging the flue gas. Pyrolyzation, defluorination, dechlorination and in-situ fluorine and chlorine absorption are conducted in an airtight rotary kiln. The airtight rotary kiln comprises three layers, the inner layer comprising an absorbing agent, the middle layer comprising a pyrolyzation material layer, and the outer layer comprising a heating layer.

It is an object of the present disclosure to provide an improved recycling plant for lithium ion battery materials and an improved recycling process for lithium ion battery materials.

### SUMMARY OF THE INVENTION

A plant for recycling lithium ion battery materials is provided which comprises a comminuting device to comminute lithium ion battery material in a comminuting space. The plant includes a drying device, arranged downstream of the comminuting device, to dry the comminuted lithium ion battery material. The plant includes an intermediate storage device arranged between the comminuting device and the drying device. The volume of an intermediate storage space of the intermediate storage device is at least five times, preferably at least ten times, the volume of the comminuting space of the comminuting device. The intermediate storage device further comprises a stirring means which is designed and intended to keep the comminuted lithium ion battery material received in the intermediate storage space in motion. The plant includes a pyrolysis device, arranged downstream of the drying device and comprising a pyrolysis space. In some embodiments, the plant includes a respective supply line for inert gas for each of the comminuting space of the comminuting device, the intermediate storage space of the intermediate storage device, a drying space of the drying device, and the pyrolysis space of the pyrolysis device.

A process for recycling lithium ion battery materials also is provided. The process comprises providing lithium ion battery material to a comminuting device, comminuting the lithium ion battery material in the comminuting device, transferring the comminuted lithium ion battery material into a drying device, drying the comminuted lithium ion battery material, transferring the comminuted and dried lithium ion battery material into a pyrolysis device, heating the comminuted and dried lithium ion battery material to a temperature of from 400° C. to 630° C. while contacting the comminuted and dried lithium ion battery material with an inert gas and with a reductive gas generated in situ by thermal decomposition of the comminuted and dried lithium ion battery material to obtain a pyrolyzed lithium ion battery material.

### BRIEF DESCRIPTION OF THE DRAWINGS

FIG. 1 is a schematic representation of an exemplary recycling plant according to the present disclosure.

### DEFINITIONS

In the present disclosure, the term “battery” not only encompasses non-rechargeable primary cells, but also accumulators, i.e. rechargeable energy storage cells. In particular, the device of the present disclosure is suitable for processing rechargeable and non-rechargeable storage cells which comprise lithium, in particular lithium compounds and/or lithium ions, and are referred to very generally in the present application as “lithium batteries”.

Furthermore, in the present disclosure, the term “drying” is also used for the removal, in particular evaporation, of the electrolyte, for example dimethyl carbonate (DMC), diethylcarbonate (DEC), and/or ethyl methyl carbonate (EMC). Although it does not only relate to the removal of liquid substances, but can also relate to the removal of solids, the term “drying” has become common in technical language for this purpose.

### DETAILED DESCRIPTION

A plant for recycling lithium ion battery materials is provided which comprises a comminuting device to comminute lithium ion battery material in a comminuting space. The plant includes a drying device, arranged downstream of the comminuting device, to dry the comminuted lithium ion battery material.

The plant includes an intermediate storage device arranged between the comminuting device and the drying device. The volume of an intermediate storage space of the intermediate storage device is at least five times, preferably at least ten times, the volume of the comminuting space of the comminuting device. The intermediate storage device further comprises a stirring means which is designed and intended to keep the comminuted lithium ion battery material received in the intermediate storage space in motion. The intermediate storage device assumes multiple functions in the plant according to the disclosure.

Firstly, the intermediate storage allows for electrochemical reactions taking place in the comminuted lithium ion battery material to subside to an extent that they do not create problems when the comminuted lithium ion battery material is supplied to the drying device.

In addition, the intermediate storage device serves as a temporary store for comminuted lithium ion battery material. In this way, the plant of the present disclosure can be operated in a batch-wise manner, such that only small amount of lithium ion battery material needs to be supplied to the comminuting device in each batch, while a larger amount of comminuted lithium ion battery material can be supplied to the drying device at once. Due to the small amount of material to be comminuted in one step, the risk of self-ignition can be practically excluded. This is particularly advantageous because in the plant of the present disclosure used batteries that are supplied to the comminuting device may have not been pre-discharged or at least not completely pre-discharged, and the residual charge of the batteries, which drives the electrochemical reactions, is unknown.

And finally, freshly comminuted batteries entering the intermediate storage space from the comminuting device are mixed by the stirring means with comminuted material that was previously brought into the intermediate storage space, in which material the electrochemical reactions have at least partially subsided. This helps to avoid the formation of partial volumes of impermissibly high temperature having an increased risk of self-ignition.

In order to further reduce the risk of self-ignition, an inert gas is additionally supplied to the comminuting device and the intermediate storage device and the drying device, i.e., a gas that at least counteracts, if not even prevents, self-ignition of the comminuted batteries while the electrochemical reactions are taking place. For example, nitrogen gas and/or carbon dioxide gas can be used as the inert gas.

All of these measures ensure that in the plant according to the disclosure, substantially unprepared batteries, in particular batteries that are not or at least not completely pre-discharged and dismantled, can be recycled in a substantially automated and therefore cost-effective process.

In an exemplary plant, 1 ton of lithium ion battery material per hour can be recycled. Lithium ion battery material are supplied to the comminuting device in the form of ten batches of 100 kg and temporarily stored in the intermediate storage device before they are passed on to the drying device. In one embodiment, the comminuting space volume of the comminuting device is approximately 0.5 m³ and/or the intermediate storage space volume of the intermediate storage device is approximately 6.0 m³ and/or the drying space volume of the drying device is approximately 3.0m³ . It has to be taken into account that the comminuted material is compacted by the conveying device, for example, a pipe screw conveyor, which transports the material from the homogenizing device to the drying device.

In order to prevent environmentally incompatible or even dangerous gases from escaping from the battery recycling plant, it is proposed in a further embodiment of the plant that the comminuting space and/or the intermediate storage space and/or the drying space are gas-tight.

In a further embodiment, the transfer device for transferring the comminuted lithium ion battery material from the comminuting device to the intermediate storage device and/or the transfer device for transferring the comminuted lithium ion battery material from the intermediate storage device to the drying device is gas-tight and connected to the devices adjoining same in a gas-tight manner.

In a further embodiment, an exhaust gas treatment device is provided which is connected to the comminuting space and/or the intermediate storage space and/or the drying space via gas supply lines and is configured to process the gases formed in the comminuting space and/or in the intermediate storage space and/or in the drying space. The person skilled in the art is familiar with the components that the exhaust gas treatment device can or should comprise depending on the gas components produced. For this reason, a detailed discussion of the design and function of the exhaust gas treatment device can be dispensed with at this point.

In order to further reduce the risk from the recycling plant, a deep-freezing device is arranged upstream of the comminuting device in a further embodiment of the plant. The deep-freezing device comprises a feed line for a liquid deep-freezing medium and is configured to deep-freeze the lithium ion battery material in the liquid deep-freezing medium before it is comminuted in the comminuting device.

Liquefied inert gas, in particular, liquid nitrogen and/or liquid carbon dioxide, can be used as the liquid deep-freezing medium. In this case, a gas head space of the deep-freezing device can also be connected to the supply line for inert gas. In this way, the deep-freezing medium evaporating due to the energy input from the lithium ion battery material can be used as an inert gas in the comminuting device and/or in the intermediate storage device and/or in the drying device.

In order to prevent excessively large fragments of the comminuted lithium ion battery material from exiting the comminuting device in the direction of the intermediate storage device, a sieve unit, for example a perforated sieve, is arranged at the outlet of the comminuting device in a further embodiment of the plant. In one embodiment, the openings of the sieve unit have a diameter of 20 mm. For instance, a universal shredder of the type NGU 0513, as sold by BHS Sonthofen GmbH, Germany, can be used as the comminuting device.

In order to ensure that the temperature in the intermediate storage space does not exceed a critical temperature value, for example 120° C., a cooling device is assigned to the intermediate storage device in some embodiments of the plant. In some embodiments, the cooling device takes the form of cooling tubes attached to a wall surrounding the intermediate storage space, which are in heat-exchange contact with the wall and through which, if necessary, cooling medium can flow.

In a further embodiment, the drying device is a negative-pressure drying device and has a pressure control unit which maintains the pressure in the drying space at a value of approximately 50 hPa. In a further embodiment, the drying device has a temperature control unit which maintains the temperature in the drying space at a value of from approximately 100° C. to approximately 120° C.

A pyrolysis device is arranged downstream of the drying device. The pyrolysis device is configured to receive the comminuted and dried lithium ion battery material from the drying device and subject them to a heat treatment in a pyrolysis space provided within the pyrolysis device. In some embodiments, the pyrolysis device includes a supply line for supplying inert gas and/or a reductive gas to the pyrolysis space of the pyrolysis device. In some embodiments of the plant, the pyrolysis device comprises an oven, for instance, an electric oven.

In some embodiments of the plant, the pyrolysis device comprises a rotary kiln. The rotary kiln is a cylindrical vessel, inclined slightly from the horizontal, which is rotated slowly about its longitudinal axis. The process feedstock is fed into the upper end of the cylinder. As the kiln rotates, material gradually moves down toward the lower end, and may undergo a certain amount of stirring and mixing.

In some embodiments of the plant, the kiln has a length in the range of from 12 to 18 m. In some embodiments of the plant, the kiln has a length in the range of from 15 to 17 m. Kiln length refers to the length of the heated zone of the kiln. Additional elements will make the overall kiln a little bit longer. In some embodiments of the plant, the inner diameter of the cylindrical tube is in the range of from 1.5 m to 2.1 m, e.g., from 1.7 m to 1.9 m.

In some embodiments of the plant, the rotary kiln features external heating elements using electric power. In some embodiments, the kiln comprises several heating zones. In some embodiments, each and every heating zone is configured to operate at a temperature in the range of from 400° C. to 650° C., e.g., from 520° C. to 600° C. In some embodiments, thermoelements are provided in each of the heating zones for measuring the temperature in the respective zone. In one embodiment, each heating zone has a length of from 0.5 m to 6 m, e.g., from 1 m to 4 m, for instance, from 1.5 m to 3 m.

In some embodiments of the plant, the kiln connects with a material exit hood at the lower end and ducts for waste gases, and features gas-tight seals at both ends of the kiln. Equipment is installed to eliminate hydrocarbons from the exhaust gas stream of the kiln before passing the exhaust gas into the atmosphere.

In some embodiments of the plant, a filling device is arranged downstream of the pyrolysis device. The filling device provides the pyrolyzed lithium ion battery material for further processing. In some embodiments, the pyrolyzed lithium ion battery material is filled into transport containers in this filling device.

In some embodiments, at least one screening device, preferably arranged upstream of the filling device, is arranged downstream of the comminuting device. In this screening device, the individual components of the comminuted and dried lithium ion battery material can be separated from one another and thus supplied to a more targeted processing. In some embodiments, at least one screening device, preferably arranged upstream of the filling device, is arranged downstream of the pyrolysis device. In this screening device, the material obtained from the pyrolysis device can be separated into fractions having different particle sizes, and the fractions can be supplied to a more targeted downstream processing. In some embodiments, at least one screening device, is arranged upstream of the pyrolysis device and at least one screening device is arranged downstream of the pyrolysis device.

The present disclosure also provides a process for recycling lithium ion battery material. The process comprises
a) providing lithium ion battery material to a comminuting device,
b) comminuting the lithium ion battery material in the comminuting device,
c) transferring the comminuted batteries into a drying device,
d) drying the comminuted batteries,
e) transferring the comminuted and dried batteries into a pyrolysis device,
f) heating the comminuted and dried batteries to a temperature of from 400° C. to 630° C. while contacting the comminuted and dried batteries with an inert gas and with a reductive gas generated in situ by thermal decomposition of the comminuted and dried batteries to obtain a pyrolyzed battery material.

At the start of the process, lithium ion battery material is provided to a comminuting device and then comminuted in the comminution device.

In some embodiments of the process, the lithium ion battery material comprises at least one chosen from a lithium ion battery, lithium ion battery waste, lithium ion battery production scrap, lithium ion cell production scrap, lithium ion cathode active material, and combinations thereof.

Lithium ion batteries may be disassembled, punched, milled, for example in a hammer mill, rotor mill, and/or shredded, for example in an industrial shredder. From this kind of mechanical processing, the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., lithium ion batteries or from production waste such as off-spec material. In some embodiments a material is obtained from mechanically treated battery scraps, for example from battery scraps treated in a hammer mill a rotor mill or in an industrial shredder.

Larger parts of the battery scrap like the housings, the wiring and the electrode carrier films may be separated mechanically such that the corresponding materials may be excluded from the lithium ion battery material employed in the process of the present disclosure. In some embodiments, the separation is done by manual or automated sorting. For example, magnetic parts can be separated by magnetic separation; non-magnetic metals can be separated by eddy-current separators. Other techniques may comprise jigs and air tables.

The comminuted lithium ion battery material is transferred into a drying device and dried. In some embodiments of the process, the comminuted and dried lithium ion battery material comprises an aluminum foil and a cathode active material.

In some embodiments, the comminuted and dried lithium ion battery material comprises carbon, nickel, cobalt, manganese, copper, aluminum, lithium, iron, phosphorus, or combinations thereof.

In some embodiments, the comminuted and dried lithium ion battery material comprises from 1 to 50 wt.-%, e.g., from 20 to 45 wt.-%, for instance, from 30 to 40 wt.-% carbon, relative to the total weight of the comminuted and dried lithium ion battery material.

In some embodiments, the comminuted and dried lithium ion battery material comprises from 0.1 to 10 wt.-%, e.g., from 1 to 7 wt.-%, for instance, from 2 to 4 wt.-% aluminum, relative to the total weight of the comminuted and dried lithium ion battery material.

In some embodiments, the comminuted and dried lithium ion battery material comprises from 0.5 to 7 wt.-%, e.g., from 1 to 5 wt.-%, for instance, from 1.5 to 3 wt.-% copper, relative to the total weight of the comminuted and dried lithium ion battery material.

In some embodiments, the comminuted and dried lithium ion battery material comprises from 0 to 45 wt.-%, e.g., from 1.5 to 30 wt.-%, for instance, from 3 to 10 wt.-% manganese, relative to the total weight of the comminuted and dried lithium ion battery material.

In some embodiments, the comminuted and dried lithium ion battery material comprises from 0.01 to 65 wt.-%, e.g., from 2 to 12 wt.-%, for instance, from 3 to 5 wt.-% cobalt, relative to the total weight of the comminuted and dried lithium ion battery material.

In some embodiments, the comminuted and dried lithium ion battery material comprises from 0.01 to 60 wt.-%, e.g., from 5 to 40 wt.-%, for instance, from 10 to 20 wt.-% nickel, relative to the total weight of the comminuted and dried lithium ion battery material.

In some embodiments, the comminuted and dried lithium ion battery material comprises from 1 to 7 wt.-%, e.g., from 1.5 to 5 wt.-%, for instance, from 2 to 4 wt.-% lithium, relative to the total weight of the comminuted and dried lithium ion battery material.

In some embodiments, the comminuted and dried lithium ion battery material comprise from 0 to 10 wt.-%, e.g., from 0.05 to 1 wt.-%, for instance, from 0.1 to 0.2 wt.-% iron, relative to the total weight of the comminuted and dried lithium ion battery material.

In some embodiments, the comminuted and dried lithium ion battery material comprise from 0.1 to 1.4 wt.-%, e.g., from 0.2 to 1 wt.-%, for instance, from 0.4 to 0.6 wt.-% phosphorus, relative to the total weight of the comminuted and dried lithium ion battery material.

The sum of the weight fractions of C, Al, Cu, Mn, Co, Ni, Li, Fe, P of the comminuted and dried lithium ion battery material is less than or equal to 100 wt.-%.

In some embodiments of the process, step b) comprises the steps of:
I. feeding the material to a first comminuting device and comminuting the material to obtain first particles having a maximum diameter of 50 mm or less;
II. feeding the first particles obtained in step I) to a second comminuting device and comminuting the first particles to obtain second particles having a maximum diameter of 20 mm or less;
III. feeding the second particles obtained in step II) to a first separating device to remove a first fine fraction consisting of particles having a size of <500 μm from the second particles;
IV. feeding the second particles obtained in step III) to a third comminuting device and comminuting the second particles to generate a second fine fraction consisting of particles having a size of <500 μm;
V. combining the first fine fraction and the second fine fraction.

The first and the second fine fraction, respectively, consist of particles having a size of <500 μm. In other words, all particles of the first and the second fine fraction, respectively, will pass through a sieve having a mesh width of 500 μm. In some embodiments, step V. involves sieving the first fine fraction and the second fine fraction through a sieve having a mesh width of not more than 500 μm, e.g., 250 μm or less. In some embodiments, the particles remaining on the sieve are washed with water to remove residual fine fraction adhering to the particles remaining on the sieve.

In some embodiments of the process, calcium carbonate is added to the comminuted lithium ion battery material prior to transferring it into the heat treatment device. In some embodiments, a stoichiometric amount of calcium carbonate, relative of the total fluorine content of the comminuted battery material, is added. For each mol of fluorine present, 0.5 mol of calcium carbonate are added. During heat treatment of the comminuted battery material, the calcium carbonate reacts with fluorine present in the comminuted battery material, thus trapping fluorine and preventing the formation of corrosive and toxic gases like hydrogen fluoride.

In some embodiments of the process, a mixture of calcium carbonate and magnesium carbonate is added to the comminuted battery material prior to transferring it into the heat treatment device. In some embodiments, a stoichiometric amount of the calcium carbonate/magnesium carbonate mixture, relative of the total fluorine content of the comminuted battery material, is added. For each mol of fluorine present, the molar amount calcium carbonate and magnesium carbonate added sums up to 0.5 mol (x mol CaCO₃+y mol MgCO₃=0.5 mol (CaCO₃+MgCO₃). In some embodiments, dolomite (CaMg(CO₃)₂) is added to the comminuted battery material prior to transferring it into the heat treatment device. During heat treatment of the comminuted battery material, the calcium carbonate/magnesium carbonate mixture reacts with fluorine present in the comminuted battery material, thus trapping fluorine and preventing the formation of corrosive and toxic gases like hydrogen fluoride. It has been found that using a mixture of calcium carbonate and magnesium carbonate further increases the leaching efficiency for lithium and reduces the amount of iron in the leach solution.

The comminuted and dried lithium ion battery material is transferred into a pyrolysis device and subsequently heated to a temperature of from 400° C. to 630° C. while contacting the comminuted and dried lithium ion battery material with an inert gas and with a reductive gas generated in situ by thermal decomposition of the comminuted and dried lithium ion battery material to obtain a pyrolyzed lithium ion battery material.

In some embodiments, the process of the present disclosure comprises providing comminuted and dried lithium ion battery material at a first temperature; heating the comminuted and dried lithium ion battery material at a second temperature ranging from 400° C. to 630° C., e.g., from 520° C. to 630° C., for instance, from 550° C. to 600° C.; contacting the comminuted and dried lithium ion battery material with an inert gas and with a reductive gas generated in situ by thermal decomposition of the comminuted and dried lithium ion battery material to obtain a pyrolyzed lithium ion battery material; and optionally cooling the a pyrolyzed lithium ion battery material to a third temperature ranging from 10° C. to 100° C., e.g., from 20° C. to 70° C.

In some embodiments, the process of the present disclosure comprises providing comminuted and dried lithium ion battery material at a first temperature. In some embodiments of the process, the first temperature ranges from −50° C. to 50° C., e.g., from −10° C. to 40° C., for instance, from 0° C. to 30° C. In a particular embodiment, the first temperature is ambient temperature.

In some embodiments, the process of the present disclosure comprises heating the comminuted and dried lithium ion battery material at a second temperature ranging from 400° C. to 630° C., e.g., from 520° C. to 630° C. In some embodiments of the process, the second temperature ranges from 530° C. to 600° C. In further embodiments, the second temperature ranges from 550° C. to 580° C.

In some embodiments of the process, the heating step comprises a temperature ramp from the first temperature to the second temperature over a period of 10 minutes to 2 hours. In some embodiments of the process, the heating step comprises a temperature ramp from the first temperature to the second temperature over a period of 30 minutes to 1 hour.

In some embodiments, a temperature ramp has average rate of temperature increase of at least 5 K per minute. In some embodiments, a temperature ramp has average rate of temperature increase of at least 10 K per minute. In some embodiments, a temperature ramp has average rate of temperature increase of at least 15 K per minute. In some embodiments, a temperature ramp has average rate of temperature increase of at least 20 K per minute. In some embodiments, a temperature ramp has average rate of temperature increase of at least 25 K per minute. In some embodiments, a temperature ramp has average rate of temperature increase of up to 50 K per minute.

In some embodiments, a temperature ramp has average rate of temperature increase ranging from 5 K per minute to 50 K per minute. In some embodiments, a temperature ramp has average rate of temperature increase ranging from 10 K per minute to 50 K per minute.

In some embodiments of the process, the heating step comprises dwelling at the second temperature for a period of time ranging from 0 minutes to 1 hour, for instance, from 10 minutes to 45 minutes, or from 15 minutes to 30 minutes.

In some embodiments of the process, the heating step comprises dwelling at one or more intermediate temperatures ranging from the first temperature to the second temperature.

In some embodiments, the process of the present disclosure comprises: providing comminuted and dried lithium ion battery material at a first temperature ranging from −50° C. to 50° C.; heating the lithium ion battery material at a second temperature ranging from 520° C. to 600° C.; wherein the heating step comprises a temperature ramp from the first temperature to the second temperature over a period of time ranging from 10 minutes to 1 hour; dwelling at the second temperature for a time ranging from 0 minutes to 1 hour; and, optionally, cooling the material to a third temperature ranging from 50° C. to 70° C.

The process of the present disclosure comprises contacting the comminuted and dried lithium ion battery material with an inert gas and with a reductive gas generated in situ by thermal decomposition of the comminuted and dried lithium ion battery material to obtain a pyrolyzed lithium ion battery material.

In some embodiments, the flow rate of the inert gas is in the range of from 100 to 300Sm³/h, e.g. 150 to 250Sm³/h, for instance, 200 Sm³/h (standard cubic meter per hour).

In some embodiments, the inert gas comprises at least one gas chosen from argon (Ar), dinitrogen (N₂), helium (He), and mixtures thereof.

In some embodiments, the reductive gas comprises at least one gas chosen from the group of hydrocarbons, dihydrogen gas (H₂), carbon monoxide (CO), and mixtures thereof.

In some embodiments of the process, the reductive gas comprises: from 5 volume % to 70 volume % C₁ to C₁₀ hydrocarbons, from 5 volume % to 95 volume % carbon dioxide (CO₂), from 0.1 volume % to 10 volume % carbon monoxide (CO), and from 0.1 volume % to 15 volume % H₂; wherein each volume % is by total volume of the reductive gas and the volume % of C₁ to C₁₀ hydrocarbons plus the volume % of CO₂ plus the volume % of H₂ is less than or equal to 100%.

In some embodiments of the process, the reductive gas comprises: from 5 volume % to 70 volume % C₁ to C₁₀ hydrocarbons, from 5 volume % to 45 volume % C₁ to C₁₀ oxy-hydrocarbons, and from 0.1 volume % to 15 volume % H₂; wherein each volume % is by total volume of the reductive gas and the volume % of C₁ to C₁₀ hydrocarbons plus the volume % C₁ to C₁₀ oxy-hydrocarbons plus the volume % of H₂ is less than or equal to 100%.

In some embodiments of the process, the heating step is performed in a rotary kiln. In some embodiments of the process, the kiln is filled with a volume of comminuted and dried batteries equal to 5 to 20%, e.g., from 7% to 16%, for instance, from 9% to 12%, of the total volume of the kiln.

In some embodiments of the process, the comminuted and dried lithium ion battery material is fed to the kiln using at least one screw conveyor.

In some embodiments of the process, the kiln rotates at 0.5 rpm to 3 rpm. In some embodiments of the process, the kiln rotates at 1.4 rpm to 2.6 rpm.. In some embodiments of the process, the kiln rotates at 1.8 rpm to 2.2 rpm.

In some embodiments of the process, overpressure is maintained in the kiln during operation to prevent air from entering the kiln.

In some embodiments of the process, hot gases pass along the kiln in the same direction as the process material (concurrent). In some embodiments of the process, the comminuted and dried lithium ion battery material and an inert gas are fed to the rotary kiln in concurrent flow. The concurrent flow makes sure that no dust emerges from the upper end of the kiln.

In some embodiments of the process, the rotary kiln is heated by external heating elements using electric power. In some embodiments of the process, the kiln comprises several heating zones. In some embodiments of the process, each and every heating zone is operated at a temperature in the range of from 400° C. to 630° C., e.g., from 520° C. to 600° C.

In some embodiments, the process of the present disclosure involves cooling the pyrolyzed lithium ion battery material obtained to a third temperature ranging from 10° C. to 100° C., e.g., from 20° C. to 50° C. In some embodiments, cooling is performed in a rotary cooler positioned at the lower end of the rotary kiln. In some embodiments, the rotary cooler has the same diameter as the rotary kiln and is cooled by a water jacket. In some embodiments of the process the inside of the rotary cooler is flushed with an inert gas, e.g., nitrogen gas.

In some embodiments of the process, the pyrolyzed lithium ion battery material exiting the rotary kiln falls into the rotary cooler, while exhaust gas leaving the rotary kiln is drawn off without being cooled. This prevents condensation of hydrocarbons present in the exhaust gas onto the composite material.

As provided herein, different process parameters may produce pyrolyzed lithium ion battery materials having different compositions and/or properties. Pyrolyzed lithium ion battery materials having, for example, a favorable composition, mechanical properties, surface hydrophilicity, and/or porosity may, e.g., result in improved processibility and/or recovery in subsequent downstream processing steps.

The present disclosure also provides a use of the pyrolyzed lithium ion battery material of the present disclosure in the recovery of valuable materials from lithium ion battery material. In some embodiments, the pyrolyzed lithium ion battery material is used as an intermediate for a downstream leaching process. For example, a black mass fraction comprising the pyrolyzed lithium ion battery material can be leached with an acidic aqueous solution comprising, e.g., sulfuric acid (H₂SO₄) to obtain a solution comprising one or more value metal ions. The solution comprising one or more value metal ions may be further purified via, e.g., solvent exchange, ion-exchange, precipitation, extraction, and/or electrolysis.

Without wishing to be bound by theory, it is believed that the pyrolyzed lithium ion battery material has beneficial properties for improving one or more downstream processes such as leaching. For instance, it is believed that the embrittlement of the pyrolyzed lithium ion battery material may, e.g., result in smaller particles that have a more beneficial surface-to-volume ratio facilitating dissolution during acid leaching. The smaller particle size may additionally facilitate subsequent transport steps, such as conveying.

The fine fractions consisting of particles having a size of <500 μm provide additional benefits in the process of the present disclosure, making it more effective and less energy-consuming. The dead volume present in pyrolysis step f) is greatly reduced, and the throughput of valuable materials is maximized. In some embodiments, the fine fractions having a particle size of <500 μm amount to about two thirds of the total mass of the lithium ion battery material, but they contain about 98 mass % of total Ni/Co/Mn, about 53 mass % of total Al, and about 90 mass % of total Cu present in the lithium ion battery material, while the coarse fractions having a particle size of 500 μm and larger amount to about one third of the total mass of the lithium ion battery material, but they only contain about 2 mass % of total Ni/Co/Mn, about 47 mass % of total Al, and about 10 mass % of total Cu present in the lithium ion battery material. So, only pyrolyzing the fine fractions which have a large metal content increases throughput in the pyrolysis step, and also reduces energy consumption and reaction time.

### EXAMPLE

The present disclosure will be explained in more detail below on the basis of an embodiment with reference to the accompanying drawing.

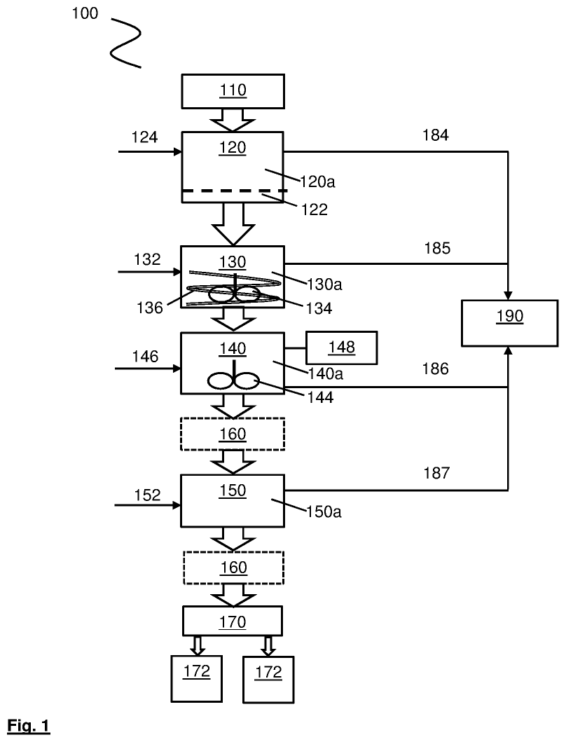

FIG. 1 is a schematic sketch of an embodiment of the plant for recycling lithium ion battery material of the present disclosure. The plant for recycling lithium ion battery material is denoted by the reference sign 100. The plant 100 comprises a comminuting device 120, an intermediate storage device 130, a drying device 140, and a pyrolysis device 150.

The plant 100 is designed for batch-wise operation. In other words, a predetermined amount of lithium ion battery material, for example 100 kg of used lithium batteries, is supplied to the comminuting device 120 by an upstream dosing device 110, which is used to divide the delivered lithium ion battery material into individual portions of the predetermined amount.

The comminuting device 120 can be equipped with a sieve device 122 on the outlet side, for example, a perforated plate with holes having a diameter of approximately 20 mm. In order to prevent environmentally incompatible gases from escaping from the comminuting device 120, said device is preferably gas-tight. In addition, the comminuting device 120 can be equipped with a supply line 124 for inert gas, via which inert gas can be supplied to the comminuting space 120a of the comminuting device 120, which reduces, if not completely excludes, the risk of self-ignition of the comminuted batteries.

After a predetermined residence time in the comminuting device 120, the comminuted lithium ion battery material is conveyed to the intermediate storage device 130. This intermediate storage device 130 is also preferably gas-tight. In addition, inert gas can also be supplied to the intermediate storage device 130 via a feed line 132 in order to be able to reduce, if not completely exclude, the risk of self-ignition of the comminuted lithium ion battery material. The intermediate storage device 130 also has stirring means 134 which constantly mix the batteries received and comminuted in the intermediate storage space 130a in order to prevent the formation of partial volumes of excessive temperature. In the event that the temperature in the intermediate storage space 130a rises too much, the intermediate storage device 130 also has a cooling device 136, for example cooling coils through which cooling medium flows, which are attached to the outer boundary wall of the intermediate storage space 130a and are in heat-exchange contact therewith.

After the comminuted lithium ion battery materials from a predetermined number of comminution processes have been received in the intermediate storage device 130, the intermediate storage space 130a is emptied in the direction of the drying device 140, the drying space 140a of which is preferably also gas-tight and which may also comprise stirring means 144. Furthermore, inert gas can also be supplied to the drying space 140a via a line 146.

In the embodiment shown, the drying device 140 is a negative-pressure drying device which dries the comminuted lithium ion battery material at a pressure of 50 hPa and at a temperature of at least 120° C. The pressure control and temperature control unit required for this purpose is denoted in FIG. 1 by reference sign 148.

After the comminuted lithium ion battery material has been dried in the drying device 140, the drying space 140a is emptied in the direction of the pyrolysis device 150.

A screening device 160 can be arranged downstream of the drying device 140, in which screening device 160 the individual components of the comminuted and dried lithium ion battery material can be separated from one another and thus supplied to a more targeted processing. In principle, it is possible to arrange a plurality of screening stages one behind the other. In some embodiments, one of the screening stages comprises a simple sieve.

The pyrolysis device 150 receives the comminuted and dried and optionally screened lithium ion battery material in a pyrolysis space 150a, where it is subjected to a heat treatment under reducing conditions to obtain a pyrolyzed lithium ion battery material. Inert gas can also be supplied to the pyrolysis space 150a via a line 152.

A screening device 160 can be arranged downstream of the pyrolysis device 150, in which screening device 160 the individual components of the comminuted and pyrolyzed lithium ion battery material can be separated from one another and thus supplied to a more targeted processing. In principle, it is possible to arrange a plurality of screening stages one behind the other. In some embodiments, one of the screening stages comprises a simple sieve.

Finally, the pyrolyzed lithium ion battery material can be filled into transport containers 172 in a filling device 170.

It should also be noted that not only the comminuting device 120, the intermediate storage device 130, the drying device 140, and the pyrolysis device 150 can be made gas-tight, but also the transfer devices 180, 181 and 182, which transfer the comminuted batteries from the comminuting device 120 to the intermediate storage device 130, from the intermediate storage device 130 to the drying device 140, and from the drying device 140 to the pyrolysis device 150, respectively.

It should also be noted that potentially environmentally hazardous gases formed in the comminuting device 120, the intermediate storage device 130, the drying device 140, and the pyrolysis device 150 can be supplied via lines 184, 185, 186, 187 to an exhaust gas treatment device 190 of a known type, in which they are processed in an environmentally friendly manner.

1. A plant for recycling lithium ion battery material, comprising:
a comminuting device configured to comminute lithium ion battery material in a comminuting space;
an intermediate storage device arranged downstream of the comminuting device and comprising an intermediate storage space with stirring means;
a drying device arranged downstream of the intermediate storage device and comprising a drying space with stirring means;
a pyrolysis device , arranged downstream of the drying device, configured to pyrolyze the comminuted and dried lithium ion battery material in a pyrolysis space; and
at least one screening device configured to separate individual components of the comminuted lithium ion battery material from one another.

2. The plant according to claim 1, wherein the comminuting device is equipped with a sieve device.

3. The plant according to claim 1, wherein the intermediate storage device is equipped with a cooling device.

4. The plant according to claim 1, wherein a screening device configured to separate individual components of the comminuted lithium ion battery material from one another is arranged upstream of the pyrolysis device.

5. The plant according to claim 1, wherein a screening device configured to separate individual components of the comminuted and pyrolyzed lithium ion battery material from one another is arranged downstream of the pyrolysis device.

6. The plant according claim 1, further comprising an exhaust gas treatment device connected to one or more of the comminuting space, the intermediate storage space, the drying space, and the pyrolysis space via respective gas supply lines and configured to process the gases formed in one or more of the comminuting space, the intermediate storage space, the drying space, and the pyrolysis space.

7. The plant according to claim 1, further comprising a filling device arranged downstream of the pyrolysis device.

8. The plant according to claim 1, wherein the pyrolysis device comprises a rotary kiln.

9. A process for recycling lithium ion battery material comprising
a) providing lithium ion battery material to a comminuting device,
b) comminuting the lithium ion battery material in the comminuting device,
c) transferring the comminuted lithium ion battery material into a drying device,
d) drying the comminuted lithium ion battery material,
e) transferring the comminuted and dried lithium ion battery material into a pyrolysis device, and
f) heating the comminuted and dried lithium ion battery material to a temperature of from 400° C. to 630° C. while contacting the comminuted and dried lithium ion battery material with an inert gas and with a reductive gas generated in situ by thermal decomposition of the comminuted and dried lithium ion battery material to obtain a pyrolyzed lithium ion battery material.

10. The process of claim 9, wherein step b) comprises the steps of:
I. feeding the material to a first comminuting device and comminuting the material to obtain first particles having a maximum diameter of 50 mm or less;
II. feeding the first particles obtained in step I) to a second comminuting device and comminuting the first particles to obtain second particles having a maximum diameter of 20 mm or less;
III. feeding the second particles obtained in step II) to a first separating device to remove a first fine fraction consisting of particles having a size of <500 μm from the second particles;
IV. feeding the second particles obtained in step III) to a third comminuting device and comminuting the second particles to generate a second fine fraction consisting of particles having a size of <500 μm; and
V. combining the first fine fraction and the second fine fraction.

11. The process of claim 9, wherein the lithium ion battery material comprises at least one selected from the group consisting of a lithium ion battery, lithium ion battery waste, lithium ion battery production scrap, lithium ion cell production scrap, lithium ion cathode active material, and combinations thereof.

12. The process of claim 9, wherein the lithium ion battery material comprises carbon, nickel, cobalt, manganese, copper, aluminum, lithium, iron, phosphorus, or combinations thereof.

13. The process of claim 9, wherein the comminuted and dried lithium ion battery material comprises from 1 wt.-% to 50 wt.-% carbon, and/or from 0.1 wt.-% to 10 wt.-% aluminum, and/or from 0.5 wt. % to 3 wt.-% copper, based on the total weight of the comminuted and dried lithium ion battery material.

14. The process of claim 9, wherein the comminuted and dried lithium ion battery material comprises from 0 wt.-% to 45 wt.-% manganese, and/or from 0.01 wt.-% to 65 wt.-% cobalt, and/or from 0.01 wt.-% to 60 wt.-% nickel, and/or from 1 wt.-% to 7 wt.-% lithium, and/or from 0 wt.-% to 10 wt.-% iron, and/or from 0.1 wt.-% to 0.4 wt.-% phosphorus, based on the total weight of the comminuted and dried lithium ion battery material.
